(19) United States
(12) Patent Application Publication
(10) Pub. No.: US 2002/0159825 A1
(43) Pub. Date: Oct. 31, 2002

(54) Tank joint parts

(76) Inventors: Hiroaki Ito, Kasugai-shi (JP); Shinji Iio, Komaki-shi (JP); Atsuo Miyajima, Inuyama-shi (JP); Tomohide Ito, Kasugai-shi (JP)

Correspondence Address: JACOBSON HOLMAN PLLC, 400 SEVENTH STREET N.W., SUITE 600, WASHINGTON, DC, 20004, US

(21) Appl. No.: 10/076,524

(22) Filed: Feb. 19, 2002

(30) Foreign Application Priority Data
Feb. 20, 2001 (JP) 2001-42872

(51) Int. Cl. B25G 3/34; F16B 12/04

(52) U.S. Cl. 403/270

(57) ABSTRACT

A tank joint part welded to the resinous outer surface of a fuel tank is formed of a resinous material such that the difference in volume swelling between materials of the tank joint part and the outer surface of the tank is 10% or less when they swell with fuel, and that the bonding strength therebetween is at least 2 MPa. The tank joint part may be comprised of a main member and a joining member if every two adjoining materials satisfy the above requirements. The main and joining members are preferably formed by two-color injection molding. The tank joint part maintains good fuel impermeability and bonding strength even after exposure to fuel.

### BACKGROUND OF THE INVENTION

1. Field of the Invention

This invention relates to tank joint parts. More particularly, it relates to any of tank joint parts such as a joint pipe or valve to be welded to a fuel tank for connecting a fuel hose or the like to the fuel tank.

2. Description of the Related Art

The integration of automotive parts has been promoted. For example, there has been an increase of cases in which parts made of a resin, such as fuel filler valves and onboard refueling vapor recovery (ORVR) valves, are attached to an automobile fuel tank made of a resin for joining fuel hoses to it. An automobile fuel tank often has a multilayer wall including a layer formed of a material of low fuel permeability, such as ethylene vinyl alcohol copolymer (EVOH), to cope with the recent gasoline evaporative regulations. It often has an outer surface layer formed of high-density polyethylene (HDPE) for water resistance and economical reasons.

A fuel filler valve is usually made of polyamide 12 reinforced with glass fiber (PA12GF) because of its low fuel permeability. Such a valve is, however, very low in weldability to the outer surface layer of high-density polyethylene (HDPE) of the fuel tank. A welding member is, therefore, interposed between the outer surface layer of the tank and the fuel filler valve. The welding member is usually of carboxylic acid- or acid anhydride-modified polyethylene which is easily weldable to both. Such related art is disclosed in Japanese Patent No. 2,715,870. German Patent DE 195 35 413 C1 discloses a multilayer welding member of high-density polyethylene (HDPE), or maleic acid-modified high-density polyethylene (HDPE).

When a joint part or a joint member thereof is welded to a fuel tank made of a resin, however, what is more important for a reduction in fuel permeation is the quality of welding after its exposure to fuel, rather than its initial quality of welding. The researches by the inventors of this invention have revealed that the use of a conventional welding member as stated above is likely to result in a cracked, or likewise defective welded joint of higher fuel permeability. There are two reasons. Firstly, there is too large a difference between two materials joined together in their volume swelling when they swell with fuel, and secondly, their joint is too low in bonding strength after immersion in fuel. Moreover, a polyethylene resin, such as carboxylic acid-modified polyethylene or high-density polyethylene (HDPE), forming a welding member is a material of high fuel permeability.

Accordingly, a conventional fuel tank, although having a layer of a material of low fuel permeability such as an ethylene-vinyl alcohol copolymer (EVOH), may not satisfy the gasoline evaporative regulations which are particularly strict in the United States.

### SUMMARY OF THE INVENTION

It is an object of this invention to provide a joint part which can be attached to a fuel tank in a favorable state ensuring its low fuel permeability.

According to a first aspect of this invention, there is provided a tank joint part welded to a resinous outer surface of a fuel tank for joining another device thereto, and made of a resinous material satisfying the following two requirements:

(1) the difference in volume swelling between materials of the tank joint part and the outer surface of the tank is 10% or less when they swell with fuel, as measured under specific conditions; and

(2) the bonding strength between the materials of the tank joint part and the outer surface of the tank is at least 2 MPa, as measured under specific conditions.

Referring to the first requirement, a test specimen measuring 10 mm square by 2 mm thick is prepared from each resinous material and dipped in a mixture of Fuel C and ethanol (containing 10% by volume of ethanol in Fuel C, a test gasoline prepared by mixing equal proportions of toluene and isooctane) at a temperature of 40° C., and after 360 hours, its volume swelling is calculated in percentage as compared with its volume prior to its dipping.

Referring to the second requirement, the two halves of a dumbbell specimen defined by ISO 527 as divided from each other along its longitudinal axis are prepared from the two kinds of materials to be tested in bonding strength, respectively, and are joined together by direct thermal welding to make a dumbbell specimen. The specimen is dipped in a mixture of Fuel C and ethanol (see above) at 40° C., and after 360 hours, it is tensed in opposite directions at a pair of opposite edges at a rate of 50 mm per minute and the bonding strength between the two halves thereof is calculated in MPa.

As the two materials joined together have only a difference in volume swelling not exceeding 10%, there is not produced along their joint any large strain causing it to crack, break or otherwise fail after its exposure to fuel. As the two materials have a bonding strength of at least 2 MPa therebetween, any strain produced along their joint by their swelling with fuel is so absorbed that it may not crack, break or otherwise fail. Thus, the tank joint part according to the first aspect of the invention can be so joined to the outer surface of the fuel tank that their joint may not crack, break or otherwise fail even after its exposure to fuel, thus preventing the higher fuel permeation.

According to a second aspect of this invention, there is provided a tank joint part welded to the resinous outer surface of a fuel tank for joining another device thereto, comprising a joining member made of a resinous material and welded to the outer surface of the tank, and a main member made of a resinous material and engaging the joining member, the resinous materials of the outer surface of the tank and the joining and main members satisfying the following two requirements:

(3) every two adjoining materials have a difference in volume swelling of 10% or less when they swell with fuel, as measured under specific conditions as explained in the first aspect; and

(4) every two adjoining materials have a bonding strength of at least 2 MPa therebetween as measured under specific conditions as expained in the first aspect.

The tank joint part according to the second aspect of the invention exerts the same effects as in the first aspect at the welded joint between the outer surface of the tank and the joining member, and at the joint between the joining and main members. Accordingly, neither the joint between the tank and the joining member nor the joint between the joining and main members cracks, breaks or otherwise fails even after its exposure to fuel, so that the tank joint part does not bring about any greater fuel permeation. The second aspect is beneficially employed when it is difficult to satisfy the above requirements (3) and (4) between the tank surface and the tank joint part, since it is not difficult to select and interpose the joining member satisfying these requirements. Thus, the second aspect provides a wide freedom of choice of materials.

According to a third aspect of this invention, the joining member is composed of at least two submembers lying between the tank wall and the main member, and satisfying the two requirements (3) and (4) as set forth before. Accordingly, the same effects as in the first aspect are exerted at each joint. Namely, none of the joints between the tank and the joining submember, between the joining submembers, and between the joining submember and the main member cracks, breaks or otherwise fails even after its exposure to fuel, so that the tank joint part does not bring about any greater fuel permeation. The third aspect is beneficially employed even when it is difficult to satisfy the above requirements (3) and (4) between the tank surface and the tank joint part, since it is not difficult to employ and interpose the submembers satisfying these requirements. Thus, the third aspect provides the wider freedom in choice of materials.

According to a fourth aspect of this invention, the main and joining members, or the main member and the joining submembers are the products of two-color or multicolor injection molding. Two-color injection molding is a method in which two kinds of molten resins are injected into a mold successively or simultaneously to make a resinous product composed of two portions or members. Multicolor injection molding is a method in which three or more kinds of molten resins are likewise injected into a mold to make a resinous product composed of three or more portions or members. The two or more members as molded generally have a still higher bonding strength therebetween. This aspect of the invention enables a still broader choice of materials varying in strength and cost, and thus more beneficial designing of the members.

According to a fifth aspect of this invention, the main and joining members, or the main member and the joining submembers are complementarily engaged with each other in cross section to have a still higher bonding strength therebetween.

According to a sixth aspect of this invention, the materials of the tank joint part, joining memeber, joining submembers and main member according to the above aspects have a fuel permeability of 2.5 mg·mm/cm²/day or less as measured under specific conditions. A test specimen having a thickness of 0.2 to 0.5 mm is prepared from each material to be tested. The specimen is used to close tightly the top opening of a container holding a mixture of Fuel C and ethanol, and the container is turned upside down so that the specimen may form the bottom of the container. The container is held in an atmosphere having a temperature of 40° C. and is weighed every day for a month. Its change in weight is used to calculate the fuel permeability of the material. The restriction of the fuel permeability of each material as stated above is desirable for ensuring the low fuel permeability of the tank joint part as a whole or its joint structure.

According to a seventh aspect of this invention, the outer surface of the tank is of high-density polyethylene (HDPE), and the tank joint part, or its joining member or submember is of an alloy of a resinous material of low fuel permeability and a polyolefin elastomer. The seventh aspect provides more preferable examples of the first to sixth aspects.

According to an eighth aspect of this invention, the resinous material of low fuel permeability is selected from among polyphenylene sulfides (PPS), polyesters, polyacetals (POM), polyamides (PA) and ethylene-vinyl alcohol copolymers (EVOH)

The above and other features and advantages of this invention will become more apparent from the following description and the accompanying drawings.

### BRIEF DESCRIPTION OF THE DRAWINGS

FIG. 1 is a sectional view of a tank joint part embodying this invention and used for connecting a fuel hose to a fuel tank;

FIGS. 2A and 2B are each a side elevational view of a part of a test joint part embodying this invention; and

FIG. 3 is a sectional view of a test assembly including a tank joint part embodying this invention, and connected to a testing apparatus.

### DETAILED DESCRIPTION OF THE INVENTION

Fuel Tank:

The fuel tank in this invention is a tank having a single-layer wall of a resin, or a multilayer wall including at least an outer surface of a resin (e.g. high-density polyethylene (HDPE)). The fuel tank is typically a gasoline tank for an automobile, though it may also be for a different kind of fuel and for a different use. A fuel hose is a typical device connected to a fuel tank by a tank joint part according to this invention, though an onboard refueling vapor recovery (ORVR) hose, a filler hose or the like may also be connected.

Tank Joint Part:

The tank joint part is a device welded to a fuel tank for connecting another device to it. Examples are fuel filler and ORVR valves, but are not limited to valve type devices, and include pipes for connecting hoses. The tank joint part can be welded to a fuel tank by any method. In order to give high bonding strength, preferable methods include a direct thermal welding, vibration welding, ultrasonic welding and laser welding. A hot gas, wire, rotation and induction heating welding methods may also be employed.

The tank joint part according to the first aspect of this invention is a molded product of a resinous material satisfying the two requirements (1) and (2) as set forth before. No specific material can be designated, since the adequacy of a particular material depends on its volume swelling with fuel and its bonding strength as compared with those of a material forming the outer surface of a fuel tank.

The tank joint part is preferably of a material having a low fuel permeability not exceeding 2.5 mg·mm/cm²/day as determined under the conditions stated before. If the outer surface of a fuel tank is of high-density polyethylene (HDPE), the joint part is preferably of an alloy of a resinous material of low fuel permeability and a polyolefin elastomer. The resinous material may be of any kind, but it is preferably of the type having only a fuel permeability not exceeding 2.5 mg·mm/cm²/day as determined under the conditions stated before. Specific examples of the preferred materials are polyphenylene sulfides (PPS), polyesters, polyacetals (POM), polyamides (PA) and ethylene-vinyl alcohol copolymers (EVOH).

The polyphenylene sulfides are preferably of the linear type. The preferred polyesters are polybutylene terephthalate (PBT), poly-1,4-cyclohexanedimethylene terephthalate (PCT), polybutylene naphthalate (PBN) and thermoplastic elastomers containing them as hard segments. The polyacetals may be either homopolymers or copolymers. The preferred polyamides are PA6, PA66, PA612, PA610, PA11, PA12, PA6T, PA9T, their copolymers and their mixtures. The preferred ethylene-vinyl alcohol copolymers (EVOH) contain 25 to 45 mols of ethylene.

There is no particular limitation to the proportions of a resinous material of low fuel permeability and a polyolefin elastomer in the alloy. If the resinous material is a polyphenylene sulfide (PPS), however, the alloy preferably contains 10 to 150 parts by weight of a polyolefin elastomer per 100 parts by weight of PPS. If the resinous material is a polyester, the alloy preferably contains 10 to 130 parts by weight of a polyolefin elastomer per 100 parts by weight of polyester. If the resinous material is a polyacetal (POM), the alloy preferably contains 10 to 100 parts by weight of a polyolefin elastomer per 100 parts by weight of POM. If the resinous material is a polyamide (PA), the alloy preferably contains 10 to 130 parts by weight of a polyolefin elastomer per 100 parts by weight of PA. If the resinous material is an ethylene-vinyl alcohol copolymer (EVOH), the alloy preferably contains 10 to 120 parts by weight of a polyolefin elastomer per 100 parts by weight of EVOH.

The alloy may contain any polyolefin elastomer, but preferably contains an olefin polymer having at least one kind of functional group selected from among an epoxy, acid anhydride or carboxyl group, a salt of a carboxyl group and a carboxylic ester. Such an olefin polymer may be used with an olefin elastomer not containing any functional group, for example, an ethylene-propylene copolymer, ethylene-butene copolymer, ethylene-propylene-diene terpolymer, styrene-butadiene copolymer, or butene-isoprene copolymer. Tank Joint Part According to the Second Aspect of the Invention:

The tank joint part according to the second aspect of this invention has a joining member of a resin welded to the outer surface of a fuel tank and a main member of a resin engaging the joining member. The joining and main members are of such materials that they and the material of the outer surface of the tank may satisfy the two requirements (3) and (4) as set forth before. In other words, the material of the joining member depends on that of the outer surface of the tank and the material of the main member depends on that of the joining member. Thus, no definite limitation can be made for the material of the joining or main member. The joining member, however, is preferably of a material having a fuel permeability not exceeding 2.5 mg·mm/cm²/day. If the outer surface of the tank is of high-density polyethylene (HDPE), the joining member is preferably of an alloy of a resinous material of low fuel permeability and a polyolefin elastomer. For details of the resinous material and elastomer and their proportions in the alloy, reference is made to the foregoing description of the joint part according to the first aspect of the invention.

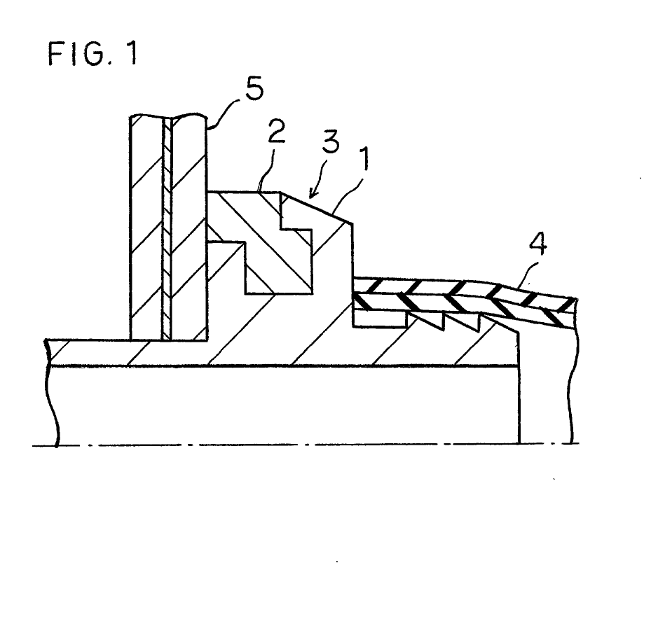

The main and joining members of the tank joint part adhere to each other and form a unitary structure. They can be prepared separately from each other and united into a unitary structure by, for example, bonding with an adhesive after or without surface treatment. They are preferably made together as a unitary structure by two-color injection molding. They are more preferably so formed by two-color injection molding that they are complementarily engaged with each other in cross section, as shown at 1 and 2 in FIG. 1, so as to increase the bonding strength therebetween. According to FIG. 1, the tank joint part 3 composed of the main and joining members 1 and 2 is welded through the joining member 2 to the fuel tank 5 for connecting the fuel hose 4 to it.

The joining member may be of the multilayer type having two or more submembers lying between the fuel tank and the main member. One of its submembers is welded to the outer surface of the tank, while the other (or another) submember engages the main member, and those submembers adhere to each other to form a unitary structure. The main member and the submember engaging it also form a unitary structure.

The outer surface of the tank, the joining submembers and the main member are of the materials satisfying the two requirements (3) and (4) as set forth before. The joining submembers are preferably of a material having a fuel permeability not exceeding 2.5 mg·mm/cm²/day as determined under the specific conditions stated before. If the outer surface of the tank is of high-density polyethylene (HDPE), the joining submembers are preferably of an alloy of a resinous material of low fuel permeability and a polyolefin elastomer. For details of the resinous material and elastomer and their proportions in the alloy, reference is made to the foregoing description of the joint part according to the first aspect of the invention.

The main member and the joining submembers of the tank joint part can be prepared separately from each other and united into a unitary structure by, for example, bonding with an adhesive after or without surface treatment. They are preferably made together as a unitary structure by multicolor injection molding. They are more preferably so formed by multicolor injection molding as to be complementarily engaged with each other in cross section, so that they may have a higher bonding strength therebetween.

### DESCRIPTION OF THE PREFERRED EMBODIMENTS

Preparation of Welding Members For Evaluation:

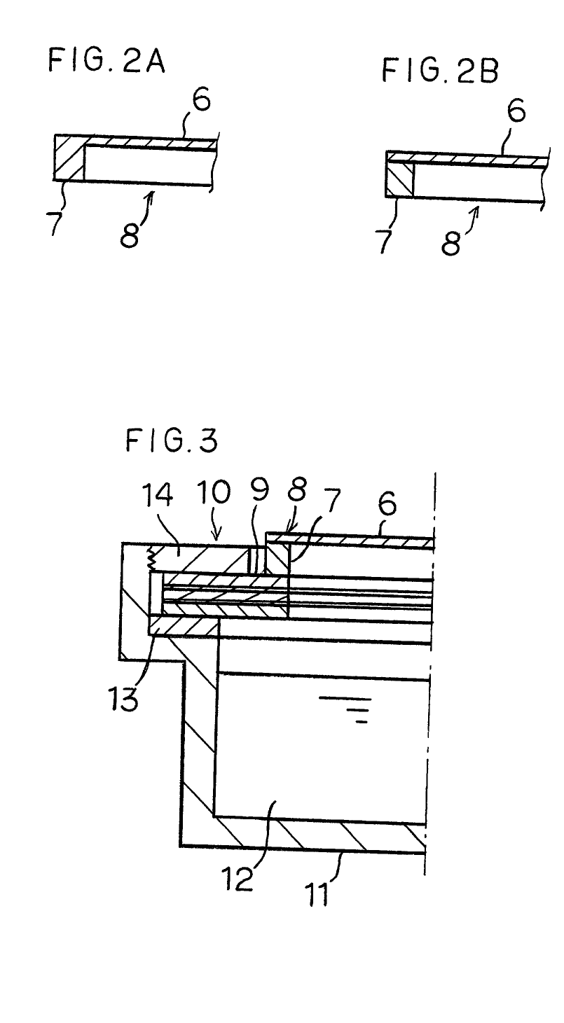

Welding members for testing purposes were prepared in accordance with Examples 1 to 26 embodying this invention and Comparative Example 1 as shown in Tables 1 to 3 below. FIG. 2A or 2B is a side elevational and sectional view of about a half of each welding member. Each welding member 8 has a circular top portion 6 having a diameter of 55 mm and a thickness of 0.5 mm and a downward flange 7 aong the periphery of the top portion 6 and having a height of 8 mm and a wall thickness of 2 mm.

The welding member according to each of Examples 1 to was prepared from the same materials in its entirety, each with different proportions as shown below. The olefin elastomer is a copolymer of an α-olefin and a glycidyl ester of α,β-unsaturated acid.

Example 1: A mixture containing 100 parts by weight of PPS and 20 parts by weight of the olefin elastomer;

Example 2: A mixture containing 100 parts by weight of PPS and 50 parts by weight of the olefin elastomer;

Example 3: A mixture containing 100 parts by weight of PPS and 100 parts by weight of the olefin elastomer;

Example 4: A mixture containing 100 parts by weight of PPS and 50 parts by weight of the olefin elastomer, and further containing 30% by weight of glass fiber;

Example 5: A mixture containing 100 parts by weight of PPS and 100 parts by weight of the olefin elastomer, and further containing 30% by weight of glass fiber.

The welding member according to Example 6 had its top portion and flange formed by two-color injection molding as shown in FIG. 2B. Its flange was formed from the same mixture as that used in Example 2, and its top portion was formed from a mixture of PPS and 30% by weight of glass fiber.

The welding member according to Example 7 also had its top portion and flange formed by two-color injection molding. Its flange was formed from the same mixture as that used in Example 3, and its top portion was formed from a mixture of PPS and 30% by weight of glass fiber.

The welding member according to each of Examples 8 to 13 was prepared from the same materials in its entirety, each with different proportions as shown below. The olefin elastomer is a copolymer of ethylene and glycidyl methacrylate.

Example 8: A mixture containing 100 parts by weight of PBT and 40 parts by weight of the olefin elastomer;

Example 9: A mixture containing 100 parts by weight of PBT and 80 parts by weight of the olefin elastomer;

Example 10: A mixture containing 100 parts by weight of PBN and 40 parts by weight of the olefin elastomer;

Example 11: A mixture containing 100 parts by weight of PBN and 80 parts by weight of the olefin elastomer;

Example 12: A mixture containing 100 parts by weight of PBT and 80 parts by weight of the olefin elastomer, and further containing 30% by weight of glass fiber;

Example 13: A mixture containing 100 parts by weight of PBN and 80 parts by weight of the olefin elastomer, and further containing 30% by weight of glass fiber.

The welding member according to Example 14 had its top portion and flange formed by two-color injection molding. Its flange was formed from the same mixture as that used in Example 9, and its top portion was formed from a mixture of PBT and 30% by weight of glass fiber.

The welding member according to Example 15 also had its top portion and flange formed by two-color injection molding. Its flange was formed from the same mixture as that used in Example 11, and its top portion was formed from a mixture of PBN and 30% by weight of glass fiber.

The welding member according to each of Examples 16 to 18 was prepared from the same materials in its entirety, each with different proportions as shown below. The polyacetal is a copolymer, and the olefin elastomer is a copolymer of an α-olefin and a glycidyl ester of α,β-unsaturated acid.

Example 16: A mixture containing 100 parts by weight of POM and 40 parts by weight of the olefin elastomer;

Example 17: A mixture containing 100 parts by weight of POM and 60 parts by weight of the olefin elastomer;

Example 18: A mixture containing 100 parts by weight of POM and 70 parts by weight of the olefin elastomer, and further containing 30% by weight of glass fiber.

The welding member according to Example 19 had its top portion and flange formed by two-color injection molding. Its flange was formed from the same mixture as that used in Example 17, and its top portion was formed from a polyacetal as a copolymer.

The welding member according to each of Examples 20 to 22 was prepared from the same materials in its entirety, each with different proportions as shown below. The olefin elastomer is a mixture of an ethylene-propylene copolymer modified with maleic anhydride and an ethylene-butene copolymer.

Example 20: A mixture containing 100 parts by weight of PA12 and 40 parts by weight of the olefin elastomer;

Example 21: A mixture containing 100 parts by weight of PA6 and 40 parts by weight of the olefin elastomer;

Example 22: A mixture containing 100 parts by weight of a PA12 nanocomposite, which is a composite of PA12 and 3% by weight of montmorillonite, and 40 parts by weight of the olefin elastomer.

The welding member according to each of Examples 23 to 25 had its top portion and flange formed by two-color injection molding. According to Example 23, its flange was formed from the same mixture as that used in Example 20, and its top portion was formed from a mixture of PA12 and 30% by weight of glass fiber. According to Example 24, its flange was formed from the same mixture as that used in Example 21, and its top portion was formed from a mixture of PA6 and 30% by weight of glass fiber. According to Example 25, its flange was formed from the same mixture as that used in Example 22, and its top portion was formed from a PA12 nanocomposite.

The welding member according to Example 26 also had its top portion and flange formed by two-color injection molding. Its flange was formed from a mixture containing 100 parts by weight of an ethylene-vinyl alcohol copolymer (EVOH) and 40 parts by weight of an olefin elastomer, and its top portion was formed from a mixture containing 100 parts by weight of EVOH and 80 parts by weight of the olefin elastomer. EVOH contained 32 mol % of ethylene, and the elastomer was a mixture of an ethylene-propylene copolymer modified with maleic anhydride and an ethylene-butene copolymer.

The welding member according to Comparative Example 1 also had its top portion and flange formed by two-color injection molding. Its top portion was formed from a mixture of PA12 and 30% by weight of glass fiber, and its flange was formed from an acid-modified polyethylene.

Preparation of Welded Products For Evaluation:

The welding member 8 according to each of Examples 1 to 26 and Comparative Example 1 had its flange 7 welded at its bottom to a sheet material 9 for a tank by a direct thermal welding method to prepare a welded product 10 for testing purposes, as shown in FIG. 3. The tank material 9 was a flat annular multilayer structure having an inside diameter equal to that of the flange 7. It was similar to the wall of a fuel tank formed from resinous materials, as it had a layer of EVOH sandwiched between two acid-modified polyethylene resin layers, an uppermost layer and a lowermost layer, both of high-density polyethylene (HDPE), all joined together by a hot press. The flange 7 was welded to one of the high-density polyethylene (HDPE) layers of the tank material 9.

Evaluation of Welded Products:

Each welded product was examined for a difference in volume swelling (%) as observed between every two adjoining portions welded together or formed by two-color injection molding when they swell with fuel, and for their bonding strength(MPa), both as determined under the specific conditions as stated before. The results are shown in Tables 1 to 3.

Each table shows, as swelling difference (%), a difference in volume swelling (%) as observed between the high-density polyethylene (HDPE) layer of the tank material 9 and the material of the flange 7 of the welding member 8, or the material of the welding member 8 if the welding material is of the same material in its entirety (HDPE/Member 1). It also shows a difference in volume swelling (%) as observed between the materials of the top portion 6 and the flange 7 of the welding member 8 (Member 1/Member 2). No value is shown wherever the welding member 8 is of the same material in its entirety.

Each table shows also the bonding strength (MPa) between the high-density polyethylene (HDPE) layer of the tank material and the flange of the welding member (HDPE/Member 1), and between the top portion and flange of the welding member (Member 1/Member 2). No value is shown wherever the welding member is of the same material in its entirety.

Each welded product was also tested for fuel permeation under the specific conditions as stated before. Reference is made to FIG. 3. A test cup 11 having an annular shoulder was fed with a mixture 12 of Fuel C and ethanol as explained before. A rubber seal 13 was placed on the shoulder of the cup 11 and the welded product 10 to be tested was placed on the seal 13. An annular cover 14 having a screw thread was threadedly fitted in the top opening of the cup 11 to tighten the welded product 10 and thereby close the cup 11 tightly. The cup 11 was turned upside down, and held in an atmosphere having a temperature of 40° C., and its change in weight including its contents was checked every day for a month as a measure for the fuel permeability of the welded product. The results are shown as Fuel permeation (mg/day) in Tables 1 to 3. The results show whether the joint between the adjoining portions welded together or formed by two-color injection molding cracked, broke, or otherwise failed after its exposure to fuel.

TABLE 1

| | | | | | | | | | Comp. |
|---|---|---|---|---|---|---|---|---|---|
| | | Example | | | | | | | Ex. |
| | | 1 | 2 | 3 | 4 | 5 | 6 | 7 | 1 |
| Swelling difference | HDPE/Member 1 | 9.7 | 5.3 | 2.1 | 7.5 | 3.3 | 5.3 | 2.1 | 8.6 |
| (%) | Member 1/Member 2 | — | — | — | — | — | 0.2 | 8.8 | 13.3 |
| Bonding strength | HDPE/Member 1 | 2.5 | 4.0 | 8.8 | 3.6 | 6.7 | 4.0 | 6.8 | 8.0 |
| (MPa) | Member 1/Member 2 | — | — | — | — | — | 7.0 | 4.6 | 1.6 |
| Fuel permeation | (mg/day) | 21 | 36 | 43 | 32 | 41 | 6 | 4.6 | 50 |

TABLE 2

| | | Example | | | | | | | |
|---|---|---|---|---|---|---|---|---|---|
| | | 8 | 9 | 10 | 11 | 12 | 13 | 14 | 15 |
| Swelling | HDPE/Member 1 | 8.9 | 4.2 | 9.2 | 5.3 | 5.1 | 6.3 | 4.2 | 5.3 |
| difference | Member 1/Member 2 | — | — | — | — | — | — | 7.6 | 8.4 |
| (%) | | | | | | | | | |
| Bonding | HDPE/Member 1 | 3.3 | 5.9 | 3.9 | 5.9 | 5.6 | 5.4 | 5.9 | 5.9 |
| strength | Member 1/Member 2 | — | — | — | — | — | — | 4.1 | 3.9 |
| (MPa) | | | | | | | | | |
| Fuel per- | (mg/day) | 38 | 45 | 30 | 38 | 43 | 36 | 10 | 6 |
| meation | | | | | | | | | |

TABLE 3

| | | Example | | | | | | | | | | |
|---|---|---|---|---|---|---|---|---|---|---|---|---|
| | | 16 | 17 | 18 | 19 | 20 | 21 | 22 | 23 | 24 | 25 | 26 |
| Swelling difference | HDPE/Member 1 | 8.3 | 6.2 | 3.4 | 6.2 | 5.0 | 8.7 | 5.5 | 5.0 | 8.7 | 5.5 | 4.3 |
| (%) | Member 1/Member 2 | — | — | — | 8.0 | — | — | — | 0.6 | 8.5 | 6.9 | 7.5 |
| Bonding strength | HDPE/Member 1 | 3.0 | 4.8 | 5.1 | 4.8 | 4.5 | 3.1 | 4.6 | 4.5 | 3.1 | 4.6 | 2.4 |
| (MPa) | Member 1/Member 2 | — | — | — | 3.9 | — | — | — | 4.9 | 6.3 | 4.6 | 4.1 |
| Fuel permeation | (mg/day) | 27 | 38 | 36 | 15 | 43 | 47 | 21 | 32 | 38 | 16 | 16 |

While the invention has been described by way of its preferred embodiments, it is to be understood that variations or modifications may be easily made by those skilled in the art without departing from the scope of this invention which is defined by the appended claims.

What is claimed is:

1. A tank joint part welded to a resinous outer surface of of a fuel tank for joining another device thereto, and made of a resinous material satisfying the following requirements:
(1) the difference in volume swelling betweeen materials of the tank joint part and the outer surface of the the tank is 10% or less when they swell with fuel, as measured under specific conditions; and
(2) the bonding strength between the materials of the tank joint part and the outer surface of the tank is at least 2 MPa, as measured under specific conditions.

2. A tank joint part welded to a resinous outer surface of a fuel tank for joining another device thereto, comprising a joining member made of a resinous material and welded to the outer surface of the tank, and a main member made of a resinous material and engaging the joining member, the resinous materials of the outer surface of the tank and the joining and main members satisfying the following requirements:
(3) every two adjoining materials have a difference in volume swelling of 10% or less when they swell with fuel, as measured under specific conditions; and
(2) every two adjoining materials have a bonding strength of at least 2 MPa therebetween, as measured under specific conditions.

3. The tank joint part according to claim 2, wherein the main and joining members form a unitary product of two-color or multicolor injection molding.

4. The tank joint part according to claim 3, wherein the main and joining members are complementarily engaged with each other in cross section.

5. The tank joint part according to claim 2, wherein the joining member is of the multilayer structure comprising at least two joining submembers lying between the tank and the main member, and every two adjoining materials satisfying the two requirements (3) and (4).

6. The tank joint part according to claim 5, wherein the main member and the joining submembers form a unitary product of two-color or multicolor injection molding.

7. The tank joint part according to claim 6, wherein the main member and teh joining submembers are complementarily engaged with each other in cross section.

8. The tank joint part according to claim 1, wherein the material of the tank joint part has a fuel permeability of 2.5 mg·mm/cm²/day or less as measured under specific conditions.

9. The tank joint part according to claim 2, wherein the materials of the main and joining members have a fuel permeability of 2.5 mg·mm/cm²/day or less as measured under specific conditions.

10. The tank joint part according to claim 5, wherein the materials of the main member and the joining submembers have a fuel permeability of 2.5 mg·mm/cm²/day or less as measured under specific conditions.

11. The tank joint part according to claim 1, wherein the outer surface of of the tank is of high-density polyethylene, and the tank joint part is of an alloy of a resinous material of low fuel permeability and a polyolefin elastomer.

12. The tank joint part according to claim 11, wherein the resinous material of low fuel permeability is selected from the group consisting of polyphenylene sulfides, polyesters, polyacetals, polyamides and ethylene-vinyl alcohol copolymers.

13. The tank joint part according to claim 2, wherein the outer surface of of the tank is of high-density polyethylene, and the main and joining members are of an alloy of a resinous material of low fuel permeability and a polyolefin elastomer.

14. The tank joint part according to claim 13, wherein the resinous material of low fuel permeability is selected from the group consisting of polyphenylene sulfides, polyesters, polyacetals, polyamides and ethylene-vinyl alcohol copolymers.

15. The tank joint part according to claim 5, wherein the outer surface of the tank is of high-density polyethylene, and the main member and the joining submembers are of an alloy of a resinous material of low fuel permeability and a polyolefin elastomer.

16. The tank joint part according to claim 15, wherein the resinous material of low fuel permeability is selected from the group consisting of polyphenylene sulfides, polyesters, polyacetals, polyamides and ethylene-vinyl alcohol copolymers.

17. The tank joint part according to claim 1, wherein the tank joint part is a fuel filler valve or an onboard refueling vapor recovery valve.

18. The tank joint part according to claim 1, wherein the tank joint part is a pipe for connecting a hose to the tank.

19. The tank joint part according to claim 1, wherein the tank is a single-layered resinous tank or a multilayered tank at least the outer surface layer of which is of a resinous material.

20. The tank joint part according to claim 1, wherein the tank is an automobile fuel tank.
